(19) United States
(12) Patent Application Publication
(10) Pub. No.: US 2026/0262642 A1
(43) Pub. Date: Sep. 10, 2026

(54) Compositions Containing Guanidine and 1,2-Benzisothiazoline-3-On

(71) Applicant: Thor GmbH, Speyer (DE)

(72) Inventors: Thomas Wunder, Neustadt a.d. Weinstrasse (DE); Roman Grabbe, Neustadt a.d. Weinstrasse (DE)

(73) Assignee: Thor GmbH, Speyer (DE)

(21) Appl. No.: 19/159,298

(22) PCT Filed: Feb. 16, 2024
(86) PCT No.: PCT/EP2024/000013

§ 371 Date: Aug. 22, 2025

(30) Foreign Application Priority Data
Feb. 23, 2023 (EP) 23000032.5

(51) Int. Cl. A01N 43/80; A01N 47/44; A01P 1/00; C08K 3/22; C08K 5/31; C08K 5/47; C09D 5/02; C09D 7/61; C09D 7/63; C11D 3/12; C11D 3/30; C11D 3/34; C11D 3/48

(52) U.S. Cl. CPC A01N 43/80; A01N 47/44; A01P 1/00; C09D 5/022; C09D 5/025; C09D 7/61; C09D 7/63; C11D 3/1213; C11D 3/30; C11D 3/349; C11D 3/48; C08K 2003/2296; C08K 5/31; C08K 5/47; C08K 2201/014

(57) ABSTRACT

The present invention relates to a composition that contains (a) guanidine and/or a salt of guanidine, and (b) 1,2-benzisothiazoline-3-on, and optionally one or more zinc compounds and/or other biocidal active substances. The invention also relates to technical products that contain the composition according to the invention.

The present invention relates to a composition comprising (a) guanidine and/or a salt of guanidine and (b) 1,2-benzisothiazolin-3-one, and optionally one or more zinc compound(s) and/or other biocidal actives. The invention also relates to industrial products comprising the composition of the invention.

Industrial products, in particular aqueous industrial products such as paints, varnishes, emulsions, detergents and cosmetic products, are customarily produced using natural or biodegradable raw materials. These raw materials and the water used as solvent are frequently contaminated with microbes, such as bacteria and fungi. If these products are produced without a preservative, they may already have high microbial counts one day after production.

In order to ensure that hygiene requirements are met by these products, and if appropriate also the constituents thereof used in production, and hence that the shelf life of the industrial products is assured, what are called biocides are usually added to the products, or directly to the constituents thereof.

One class of biocides used for preservation of aqueous industrial products such as paints, renders, detergents and cleaning compositions or glazes, or constituents thereof, is that of the 3-isothiazolin-3-ones. This substance class includes antimicrobially very active compounds with a profile of action that differs to some degree. It is often also the case that synergistic combinations of different 3-isothiazolin-3-ones are used in order to reduce the amount of biocides used. For example, WO 99/08530 A1 thus suggests the combined use of methylisothiazolin-3-one and 1,2-benzoisothiazolin-3-one.

EP-B 1 030 558 likewise discloses a synergistic biocidal composition containing 2-methylisothiazolin-3-one and 3-iodo-2-propynyl N-butylcarbamate. This synergistic composition is suitable even in low concentrations for controlling microorganisms.

A further class of biocides is that of what are called the alkylguanidinium salts and also polyguanidinium salts. For example, it is thus known from the “Directory of microbicides for the protection of materials”, Springer 2005, pages 726 to 731, that an antimicrobial effect is possessed by medium- and long-chain guanidines and biguanidines, such as cocopropylenediamine-1,5-bisguanidinium acetates, bis(guanidinooctyl)amine triacetates, poly(hexamethylenebiguanidine) hydrochlorides, di(4′-chlorophenyldiguanido)hexanes, chlorhexidine digluconates, chlorhexidine diacetates.

Also known is use of such medium- and long-chain guanidine compounds together with other antimicrobial and/or fungicidal actives. For instance, a known example is the combination with 3-iodo-2-propynyl butylcarbamate, or formaldehyde depots. For example, EP 0 891 710 A1 teaches the combined use of dodecylguanidine hydrochloride and IPBC. However, the use of dodecylguanidine salts for preservation of paint compositions and polymer dispersions has been found to be problematic; for instance, incompatibilities in the form of coagulations were observable when these salts were added.

Proceeding from the prior art discussed above, there is a need for further compositions, the components of which interact synergistically and can therefore be used in lower concentrations when used at the same time, compared to the concentrations necessary in the case of the individual components.

The invention achieves this object by a composition, preferably an aqueous composition, comprising:
(a) guanidine and/or at least one salt of unsubstituted guanidine and
(b) 1,2-benzisothiazolin-3-one.

The composition of the invention has the advantage that the guanidine or its salt, component (a), which has not been known as an antimicrobial active to date, and the 1,2-benzisothiazolin-3-one, component (b), interact synergistically, and can therefore be used in low concentrations when used at the same time, compared to low concentrations in the case of individual components. As a result, microorganisms, such as bacteria and fungi, that are present in the composition from the production, for example, are effectively and efficiently inactivated in spite of a lower concentration of components (a) and (b).

The composition of the invention contains guanidine and/or at least one salt of unsubstituted guanidine as component (a). What is meant by “at least one salt or at least one further component” within the context of the present invention is that the composition contains a single salt or a single component or compound, or else several, i.e. two, three, four, five or more salts or components or compounds.

For the purposes of the present invention, what is meant by guanidine and/or a salt of unsubstituted guanidine is that the composition contains, as component (a), guanidine and/or thus optionally also one or more salts of unsubstituted guanidine. The guanidine is the compound of the formula shown below:

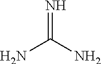

The salts of unsubstituted guanidine or guanidine salts in the context of the present invention are guanidine or guanidinium salts of the general formula shown below:

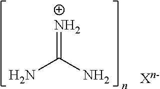

where n is 1, 2 or 3, and where the counterion Xⁿ⁻ is, for example, chloride, carbonate, nitrate, sulfate, thiocyanate, phosphate, hydrogencarbonate, guanidine silicates, formate, acetate or citrate.

In a preferred embodiment of the invention, the composition of the invention contains guanidine hydrochloride and/or guanidine carbonate as component (a), and in a particularly preferred embodiment of the invention the composition contains guanidine carbonate as component (a).

As component (b), the composition of the invention comprises 1,2-benzisothiazolin-3-one, which may also be present in the composition in the form of its alkali metal salts. The composition of the invention therefore comprises, as component (b), 1,2-benzisothiazolin-3-one and/or its sodium, potassium or lithium metal salts or mixtures thereof.

In the context of the present invention, both the amounts of the respective components (a) and (b) and the weight ratios of the components (a) and (b) to one another are specified. The amounts refer respectively to the lead structures, the guanidine, or to the lead structure of the component (b), 1,2-benzisothiazolin-3-one. The determination of the specified weight ratios is likewise based in each case on the content in respect of the guanidine, not including any counterion, and the content of 1,2-benzisothiazolin-3-one as component (b), not including any counterion, in the composition.

In a preferred embodiment, the invention relates to a composition containing guanidine and/or its salt and 1,2-benzisothiazolin-3-one, in a weight ratio of guanidine to 1,2-benzisothiazolin-3-one in the range from 1.3:1 to 309:1, preferably in the range from 1.3:1 to 200:1, more preferably in the range from 1.3:1 to 100:1, where the basis in the determination of the weight ratio in each case is the content with respect to the guanidine, not including any counterion, and the 1,2-benzisothiazolin-3-one content in the composition.

The amount of component (a), guanidine and/or its salt, which is present in the composition of the invention may vary over wide ranges and is generally in the range from 100 to 10 000 ppm, preferably in an amount in the range from 200 to 7500 ppm, and more preferably in an amount in the range from 300 to 5000 ppm, where the respectively specified amount relates to the guanidine content in the overall composition.

The amount of component (b), 1,2-benzisothiazolin-3-one and/or its alkali metal salt, which is present in the composition of the invention may vary over wide ranges and is generally in the range from 1 to 1000 ppm, preferably in the range from 10 to 750 ppm, more preferably in the range from 25 to 500 ppm, where the specified amount relates in each case to the 1,2-benzisothiazolin-3-one content in the overall composition.

The composition of the invention is an aqueous composition, the water content of which may vary over wide ranges. Typically, the composition is characterized in that it has a water content of greater than 1% by weight, preferably of greater than 10% by weight, more preferably of greater than 20% by weight, based on the overall composition.

The pH of the composition of the invention may vary over wide ranges. In one embodiment of the invention, the composition is characterized in that it has a pH in the range from pH 4.5 to pH 12, preferably in the range from pH 5.0 to 11.5, more preferably in the range from pH 5.5 to pH 11. The pH can be adjusted to the claimed range with the aid of measures familiar to the person skilled in the art.

The composition, especially the aqueous composition, according to the present invention is generally an industrial product, especially an aqueous industrial product, selected from the group consisting of lignosulfonates and starch preparations in paints, colors, varnishes, glazes and renders, emulsions, latices, polymer dispersions, chalk slurries, mineral slurries, ceramic compounds, adhesives, fragrances, casein-containing products, starch-containing products, bitumen emulsions, surfactant solutions, fuels, detergents, cleaning compositions, pigment pastes and pigment dispersions, inks, lithography fluids, thickeners, cosmetic products, toiletries, water cycles, wood processing fluids, petroleum production fluids, paper processing fluids, leather manufacturing fluids, textile manufacturing fluids, drilling and cutting oils, hydraulic fluids, cooling lubricants and biocide products. In a preferred embodiment of the invention, the composition is an industrial product, especially an aqueous industrial product, selected from the group consisting of paints, colors, varnishes, glazes and renders, emulsions, latices, polymer dispersions, mineral slurries, pigment pastes and pigment dispersions, detergents and cleaning compositions.

Component (c) is generally selected from the group consisting of zinc oxide, zinc chloride, zinc sulfate, zinc phosphate, zinc carbonate, zinc hydroxycarbonate ([ZnCO₃]₂·[Zn(OH)₂]₃), zinc ascorbate, zinc hydroxide, zinc dehydroacetate and zinc carboxylate. In a preferred embodiment of the invention, component (c) is selected from the group consisting of zinc oxide and zinc carbonate, and in a particularly preferred embodiment component (c) is zinc oxide.

In this embodiment, the invention therefore relates in particular to an aqueous composition comprising:
(a) guanidine and/or at least one salt of unsubstituted guanidine,
(b) 1,2-benzisothiazolin-3-one and
(c) one or more zinc compound(s) selected from the group consisting of zinc oxide, zinc chloride, zinc sulfate, zinc phosphate, zinc carbonate, zinc hydroxycarbonate ([ZnCO₃]₂·[Zn(OH)₂]₃), zinc ascorbate, zinc hydroxide, zinc dehydroacetate and zinc carboxylate.

The composition of the invention in this embodiment in which component (c) is also present has the advantage that the at least one zinc compound, component (c), interacts synergistically in each case with components (a) and (b), which means that the content of components (a), (b) and (c) in the composition can be lowered even further while maintaining antimicrobial efficacy.

The weight ratio of components (a) to (c) to one another may vary over wide ranges. In a preferred embodiment, the composition of the invention is characterized in that the weight ratio of (a) to (c) is in the range from 0.77:1 to 12:1, preferably in the range from 1:1 to 10:1, where the basis in the determination of the weight ratio in each case is the content with respect to the guanidine, not including any counterion, and the zinc content.

The amount of component (c), the at least one zinc compound, present in the composition of the invention may vary over wide ranges, and is in the range from 10 to 5000 ppm, preferably in the range from 25 to 2500 ppm, more preferably in the range from 50 to 1000 ppm, based in each case on the zinc content in the composition.

In a preferred embodiment of the invention, the composition comprises, as a further component:
(d) one or more compound(s) selected from sodium pyrithione, zinc pyrithione, 5-chloro-2-methyl-4-isothiazoline-3-one, 2-methyl-4-isothiazoline-3-one, N-methyl-1,2-benzisothiazoline-3-one, N-butyl-1,2-benzisothiazoline-3-one, octylisothiazolinone, bronopol, dibromonitrilopropionamide, iodopropynyl butylcarbamate, phenoxyethanol and dibromodicyanobutane.

The composition of the invention in this embodiment in which the component (d) is also present has the advantage that the at least one compound, selected from the group consisting of sodium pyrithione, zinc pyrithione, 5-chloro-2-methyl-4-isothiazoline-3-one, 2-methyl-4-isothiazoline-3-one, N-methyl-1,2-benzisothiazoline-3-one, N-butyl-1,2-benzisothiazoline-3-one, octylisothiazolinone, bronopol, dibromonitrilopropionamide, iodopropynyl butylcarbamate, phenoxyethanol and dibromodicyanobutane, interacts synergistically with component (a), which means that the content of components (a), (b), optionally (c) and (d) in the composition can be lowered even further while maintaining antimicrobial efficacy.

In this embodiment, the invention therefore relates in particular to an aqueous composition comprising:
(a) guanidine and/or at least one salt of unsubstituted guanidine,
(b) 1,2-benzisothiazolin-3-one, optionally:
(c) one or more zinc compound(s) selected from the group consisting of zinc oxide, zinc chloride, zinc sulfate, zinc phosphate, zinc carbonate, zinc hydroxycarbonate ([ZnCO₃]₂·[Zn(OH)₂]₃), zinc ascorbate, zinc hydroxide, zinc dehydroacetate and zinc carboxylate,
and
(d) one or more compound(s) selected from sodium pyrithione, zinc pyrithione, 5-chloro-2-methyl-4-isothiazoline-3-one, 2-methyl-4-isothiazoline-3-one, N-methyl-1,2-benzisothiazoline-3-one, N-butyl-1,2-benzisothiazoline-3-one, octylisothiazolinone, bronopol, dibromonitrilopropionamide, iodopropynyl butylcarbamate, phenoxyethanol and dibromodicyanobutane.

The amount of component (d) present in the composition of the invention may vary over wide ranges. In a preferred embodiment of the invention, the composition is characterized in that it comprises, as component (d):
(d1) phenoxyethanol in an amount in the range from 100 to 10 000 ppm, preferably in an amount in the range from 250 to 7500 ppm, more preferably in an amount in the range from 500 to 5000 ppm, and/or (d2) one or more compounds selected from sodium pyrithione, zinc pyrithione, 5-chloro-2-methyl-4-isothiazoline-3-one, 2-methyl-4-isothiazoline-3-one, N-methyl-1,2-benzisothiazoline-3-one, N-butyl-1,2-benzisothiazoline-3-one, octylisothiazolinone, bronopol, dibromonitrilopropionamide, iodopropynyl butylcarbamate, and dibromodicyanobutane in a total amount in the range from 1 to 1000 ppm, preferably in a total amount in the range from 1 to 750 ppm, and more preferably in a total amount in the range of 1 to 500 ppm.

In a preferred embodiment of the invention, the invention therefore relates to an aqueous composition in particular, comprising:
(a) 100 to 10 000 ppm, preferably 200 to 7500 ppm, more preferably 300 to 5000 ppm, of guanidine and/or at least one salt of guanidine,
(b) 1 to 1000 ppm, preferably 10 to 750 ppm, more preferably 25 to 500 ppm, of 1,2-benzisothiazolin-3-one,
(c) 0 to 5000 ppm, preferably 10 to 5000 ppm, more preferably 25 to 2500 ppm, based on the amount of zinc in the composition, of one or more zinc compound(s) selected from the group consisting of zinc oxide, zinc chloride, zinc sulfate, zinc phosphate, zinc carbonate, zinc hydroxycarbonate ([ZnCO₃]₂·[Zn(OH)₂]₃), zinc ascorbate, zinc hydroxide, zinc dehydroacetate and zinc carboxylate,
(d1) 0 to 10 000 ppm, preferably 250 to 7500 ppm, more preferably 500 to 5000 ppm, of phenoxyethanol, and
(d2) 0 to 1000 ppm, preferably 1 to 1000 and more preferably 1 to 750 ppm of one or more compound(s) selected from sodium pyrithione, zinc pyrithione, 5-chloro-2-methyl-4-isothiazoline-3-one, 2-methyl-4-isothiazoline-3-one, N-methyl-1,2-benzisothiazoline-3-one, N-butyl-1,2-benzisothiazoline-3-one, octylisothiazolinone, bronopol, dibromonitrilopropionamide, iodopropynyl butylcarbamate, and dibromodicyanobutane.

In one embodiment of the invention, the invention relates to an aqueous composition comprising:
(a) 200 to 7500 ppm, more preferably 300 to 5000 ppm, of guanidine and/or at least one salt of guanidine,
(b) 1 to 1000 ppm, preferably 10 to 750 ppm, more preferably 25 to 500 ppm, of 1,2-benzisothiazolin-3-one,
(c) 10 to 5000 ppm, preferably 50 to 1000 ppm, of zinc oxide,
(d1) 1 to 150 ppm, preferably 2 to 100 ppm, more preferably 5 to 50 ppm, of 2-methyl-4-isothiazolin-3-one and
(d2) 1 to 100 ppm, preferably 2 to 50 ppm, more preferably 5 to 30 ppm, of 5-chloro-2-methyl-4-isothiazolin-3-one.

In a particularly preferred embodiment, the above-defined aqueous composition comprises, as component:
(a) 300 to 10 000 ppm, preferably 500 to 7500 ppm, more preferably 750 to 5000 ppm, of guanidine carbonate and/or guanidine hydrochloride.

The above-defined aqueous composition is an aqueous industrial product selected from the group consisting of paints, colors, varnishes, glazes and renders, emulsions, latices, polymer dispersions, mineral slurries, pigment pastes and pigment dispersions, detergents and cleaning compositions.

In a further embodiment of the invention, the invention relates to an aqueous composition comprising:
(a) 200 to 7500 ppm, more preferably 300 to 5000 ppm, of guanidine and/or at least one salt of guanidine,
(b) 1 to 1000 ppm, preferably 10 to 750 ppm, more preferably 25 to 500 ppm, of 1,2-benzisothiazolin-3-one,
(d1) 1 to 150 ppm, preferably 2 to 100 ppm, more preferably 5 to 50 ppm, of 2-methyl-4-isothiazolin-3-one and
(d2) 1 to 100 ppm, preferably 2 to 50 ppm, more preferably 5 to 30 ppm, of 5-chloro-2-methyl-4-isothiazolin-3-one.

In a particularly preferred embodiment, the above-defined aqueous composition comprises, as component:
(a) 300 to 10 000 ppm, preferably 500 to 7500 ppm, more preferably 750 to 5000 ppm, of guanidine carbonate and/or guanidine hydrochloride.

The above-defined aqueous composition is preferably an aqueous industrial product selected from the group consisting of emulsions, latices, polymer dispersions, pigment dispersions, detergents and cleaning compositions, more preferably an aqueous industrial product selected from the group consisting of emulsions and latices.

It is particularly advantageous when the composition of the invention contains, as component(s) (d):
phenoxyethanol in an amount in the range from 100 to 10 000 ppm, preferably in an amount in the range from 250 to 7500 ppm, more preferably in an amount in the range from 500 to 5000 ppm, and/or
sodium pyrithione in an amount in the range from 10 to 1000 ppm, preferably in an amount in the range from 20 to 750 ppm, more preferably in an amount in the range from 30 to 500 ppm, and/or
zinc pyrithione in an amount in the range from 10 to 1000 ppm, preferably in an amount in the range from 20 to 750 ppm, more preferably in an amount in the range from 30 to 500 ppm, and/or
5-chloro-2-methyl-4-isothiazolin-3-one in an amount in the range from 0.5 to 200 ppm, preferably in an amount in the range from 1 to 100 ppm, more preferably in an amount in the range from 2 to 50 ppm, and/or
2-methyl-4-isothiazolin-3-one in an amount in the range from 0.5 to 200 ppm, preferably in an amount in the range from 1 to 150 ppm, more preferably in an amount in the range from 2 to 100 ppm, and/or
N-methyl-1,2-benzisothiazolin-3-one in an amount in the range from 1 to 1000 ppm, preferably in an amount in the range from 2 to 750 ppm, more preferably in an amount in the range from 5 to 500 ppm, and/or
N-butyl-1,2-benzisothiazolin-3-one in an amount in the range from 5 to 2500 ppm, preferably in an amount in the range from 10 to 2000 ppm, more preferably in an amount in the range from 10 to 1500 ppm, and/or
octylisothiazolinone in an amount in the range from 1 to 2500 ppm, preferably in an amount in the range from 5 to 2000 ppm, more preferably in an amount in the range from 10 to 1500 ppm, and/or
bronopol in an amount in the range from 1 to 1000 ppm, preferably in an amount in the range from 5 to 750 ppm, more preferably in an amount in the range from 10 to 500 ppm, and/or
dibromonitrilopropionamide in an amount in the range from 1 to 1000 ppm, preferably in an amount in the range from 5 to 750 ppm, more preferably in an amount in the range from 10 to 500 ppm, and/or
iodopropynyl butylcarbamate in an amount in the range from 10 to 5000 ppm, preferably in an amount in the range from 25 to 4500 ppm, more preferably in an amount in the range from 50 to 4000 ppm, and/or
dibromodicyanobutane in an amount in the range from 1 to 1000 ppm, preferably in an amount in the range from 5 to 750 ppm, more preferably in an amount in the range from 10 to 500 ppm.

This is because it has been found to be surprisingly advantageous in the context of the invention when the composition of the invention containing the components (a) and (b) and optionally also (c) contains the above-cited component(s) (d) in the amounts specified in each case. This can achieve a further synergistic increase in the antimicrobial efficacy of the composition of the invention that already obtains components (a) and (b) and optionally also (c).

In the context of the present invention, it has also been found to be particularly advantageous when:

In the case of the presence of phenoxyethanol as component (d), the weight ratio of guanidine and/or its salt to phenoxyethanol is in the range from 0.13:1 to 3.6:1, where the basis in the determination of the weight ratio in each case is the content with respect to the guanidine, not including any counterion, in the composition.

In the case of the presence of sodium pyrithione as component (d), the weight ratio of guanidine and/or its salt to sodium pyrithione is in the range from 3.6:1 to 180:1, preferably in the range from 3.6:1 to 100:1, more preferably in the range from 3.6:1 to 50:1, where the basis in the determination of the weight ratio in each case is the content with respect to the guanidine, not including any counterion, in the composition.

In the case of the presence of zinc pyrithione as component (d), the weight ratio of guanidine and/or its salt to zinc pyrithione is in the range from 3.6:1 to 180:1, preferably in the range from 3.6:1 to 100:1, more preferably in the range from 3.6:1 to 50:1, where the basis in the determination of the weight ratio in each case is the content with respect to the guanidine, not including any counterion, in the composition.

In the case of the presence of 5-chloro-2-methyl-4-isothiazolin-3-one as component (d), the weight ratio of guanidine and/or its salt to 5-chloro-2-methylisothiazolin-3-one is in the range from 62:1 to 9270:1, preferably in the range from 62:1 to 500:1, more preferably in the range from 62:1 to 300:1, where the basis in the determination of the weight ratio in each case is the content with respect to the guanidine, not including any counterion, in the composition.

In the case of the presence of 2-methyl-4-isothiazolin-3-one as component (d), the weight ratio of guanidine and/or its salt to 2-methylisothiazolin-3-one is in the range from 10.3:1 to 773:1, preferably in the range from 10.3:1 to 500:1, more preferably in the range from 10.3:1 to 300:1, where the basis in the determination of the weight ratio in each case is the content with respect to the guanidine, not including any counterion, in the composition.

In the case of the presence of N-methyl-1,2-benzisothiazolin-3-one as component (d), the weight ratio of guanidine and/or its salt to N-methyl-1,2-benzisothiazolin-3-one is in the range from 7.8:1 to 618:1, preferably in the range from 7.8:1 to 400:1, more preferably in the range from 7.8:1 to 300:1, where the basis in the determination of the weight ratio in each case is the content with respect to the guanidine, not including any counterion, in the composition.

In the case of the presence of N-butyl-1,2-benzisothiazolin-3-one as component (d), the weight ratio of guanidine and/or its salt to N-butyl-1,2-benzisothiazolin-3-one is in the range from 0.52:1 to 309:1, preferably in the range from 0.52:1 to 200:1, more preferably in the range from 0.52:1 to 100:1, where the basis in the determination of the weight ratio in each case is the content with respect to the guanidine, not including any counterion, in the composition.

In the case of the presence of octylisothiazolinone as component (d), the weight ratio of guanidine and/or its salt to N-octylisothiazolin-3-one is in the range from 1.4:1 to 82:1, preferably in the range from 1:4:1 to 50:1, where the basis in the determination of the weight ratio in each case is the content with respect to the guanidine, not including any counterion, in the composition.

In the case of the presence of bronopol as component (d), the weight ratio of guanidine and/or its salt to bronopol is in the range from 7.8:1 to 824:1, preferably in the range from 7.8:1 to 200:1, more preferably in the range from 7.8:1 to 100:1, where the basis in the determination of the weight ratio in each case is the content with respect to the guanidine, not including any counterion, in the composition.

In the case of the presence of dibromonitrilopropionamide as component (d), the weight ratio of guanidine and/or its salt to 2,2-dibromo-3-nitrilopropionamide is in the range from 7.8:1 to 3090:1, preferably in the range from 7.8:1 to 250:1, more preferably in the range from 7.8:1 to 100:1, where the basis in the determination of the weight ratio in each case is the content with respect to the guanidine, not including any counterion, in the composition.

In the case of the presence of iodopropynyl butylcarbamate as component (d), the weight ratio of guanidine and/or its salt to iodopropynyl butylcarbamate is in the range from 0.83:1 to 103:1, preferably in the range from 1:1 to 90:1, more preferably in the range from 1:1 to 80:1, where the basis in the determination of the weight ratio in each case is the content with respect to the guanidine, not including any counterion, in the composition.

In the case of the presence of dibromodicyanobutane as component (d), the weight ratio of guanidine and/or its salt to dibromodicyanobutane is in the range from 0.78:1 to 309:1, preferably in the range from 0.8:1 to 200:1, more preferably in the range from 0.8:1 to 100:1, where the basis in the determination of the weight ratio in each case is the content with respect to the guanidine, not including any counterion, in the composition.

This is because it has been found to be surprisingly advantageous in the context of the invention when component (a), the guanidine and/or its salt, and the above-specified component(s) (d) are in the specified synergistic ratios to one another. This can achieve a further synergistic increase in the antimicrobial efficacy of the composition of the invention that already obtains components (a) and (b) and optionally also (c).

In a further embodiment, the present invention relates to the use of:
(a) guanidine and/or a salt of unsubstituted guanidine

for improvement of the antimicrobial efficacy of
(b) 1,2-benzisothiazolin-3-one.

As can be inferred from the examples adduced below, the use of guanidine or its salt, which has not been known as an antimicrobial active to date, leads to a surprising synergistic increase in the effect of the 1,2-benzisothiazolin-3-one.

In a preferred embodiment of the invention, the invention further relates to the use of:
(a) 100 to 10 000 ppm, preferably 200 to 7500 ppm, more preferably 300 to 5000 ppm, of guanidine and/or at least one salt of guanidine,
for improvement of the antimicrobial efficacy of an aqueous composition containing:
(a) 100 to 10 000 ppm, preferably 200 to 7500 ppm, more preferably 300 to 5000 ppm, of guanidine and/or at least one salt of guanidine,
(b) 1 to 1000 ppm, preferably 10 to 750 ppm, more preferably 25 to 500 ppm, of 1,2-benzisothiazolin-3-one,
(c) 0 to 5000 ppm, preferably 10 to 5000 ppm, more preferably 25 to 2500 ppm, based on the amount of zinc in the composition, of one or more zinc compound(s) selected from the group consisting of zinc oxide, zinc chloride, zinc sulfate, zinc phosphate, zinc carbonate, zinc hydroxycarbonate ([ZnCO₃]₂·[Zn(OH)₂]₃), zinc ascorbate, zinc hydroxide, zinc dehydroacetate and zinc carboxylate,
(d1) 0 to 10 000 ppm, preferably 100 to 10 000 ppm, more preferably 250 to 7500 ppm, most preferably 500 to 5000 ppm, of phenoxyethanol, and
(d2) 0 to 1000 ppm, preferably 1 to 1000 and more preferably 1 to 750 ppm of one or more compound(s) selected from sodium pyrithione, zinc pyrithione, 5-chloro-2-methyl-4-isothiazoline-3-one, 2-methyl-4-isothiazoline-3-one, N-methyl-1,2-benzisothiazoline-3-one, N-butyl-1,2-benzisothiazoline-3-one, octylisothiazolinone, bronopol, dibromonitrilopropionamide, iodopropynyl butylcarbamate, and dibromodicyanobutane.

The present invention further provides a method of producing the aqueous compositions of the invention, comprising the mixing of the components defined above.

The following examples serve for further illustration of the present invention:

### Study of the Synergistic Interaction

A combination of guanidine (added in the form of guanidine hydrochloride) and 1,2-benzothiazolin-3-one (BT was examined for their synergistic interaction.

The test organism used was a Gram-negative bacterial species from the group of pseudomonads, Pseudomonas spec. DSM 115322. For this purpose, mixtures with different concentrations of the respective actives were prepared and tested for their effect on pseudomonads. The test was run in Müller-Hinton broth MHB with a cell density of 10⁶ microbes per ml.

The incubation was run in microplates at 30° C. for 48 hours. After 48 hours, the batches were evaluated for turbidity resulting from growth, and optical density was additionally determined photometrically. In this way, the minimum inhibitory concentrations (MICs) of the two actives were determined individually and in combination.

The synergism that occurred was represented numerically by calculating the synergy index (SI). The calculation was done according to the standard method of F. C. Kull et al., Applied Microbiology, vol. 9 (1961), p. 538.

This involves calculating the synergy index (SI) by the following formula:

$$Synergy index SI = {Q}_{a} / {Q}_{A} + {Q}_{b} / {Q}_{B}$$

Qₐ=concentration of component A in the A+B mixture
Q_{A}=concentration of component A as the sole biocide
Q_{b}=concentration of component B in the A+B mixture
Q_{B}=concentration of component B as the sole biocide

If the synergy index is greater than 1, this means that there is antagonism. If the synergy index assumes the value 1, this means that the effects of the two biocides/compounds are additive. If the synergy index assumes a value of less than 1, this means that there is synergism between the two biocides/compounds.

### EXAMPLE 1: STUDY OF THE SYNERGISTIC INTERACTION BETWEEN GUANIDINE AND 1,2-BENZISOTHIAZOLIN-3-ONE (BIT)

Calculation of the synergy index of guanidine and BIT with respect to Pseudomonas spec. DSM 115322 with an incubation time of 48 hours at 30° C.

TABLE 1

| Qa | | |
|---|---|---|
| (guanidine) | | Synergy index |
| [ppm] | Qb (BIT) [ppm] | Qa/QA + Qb/QB |
| 0 | 300 | 1.00 |
| 309 | 250 | 0.87 |
| 1545 | 175 | 0.75 |
| 3090 | 100 | 0.67 |
| 4635 | 75 | 0.75 |
| 6180 | 50 | 0.83 |
| 7725 | 25 | 0.92 |
| 9269 | 0 | 1.00 |

Qa: Concentration of guanidine in the mixture that shows an endpoint
QA: Concentration of guanidine as the sole agent that shows an endpoint
Qb: Concentration of BIT in the mixture that shows an endpoint
QB: Concentration of BIT as the sole agent that shows an endpoint

Table 1 shows that the optimum synergism, i.e. the lowest synergy index (0.67) of a composition of guanidine and BIT, is at a ratio of 3090 ppm guanidine to 100 ppm BIT. Synergism can be demonstrated when the weight ratio of guanidine to BIT is in the range from 1.3:1 to 309:1.

In examples 2 to 4 below, synergistic interaction between guanidine and benzisothiazolinone (BIT) with respect to microbial infestation was studied using an emulsion paint and a detergent or cleaning composition by adding particular amounts of guanidine salts and benzisothiazolinone and examining their stability against microbial infestation:

The paint tested was an emulsion paint based on styrene-acrylate binder (PVC 77%, pH 8.8) for indoor use, produced in the laboratory, without addition of the usual preservatives. The detergent was a heavy-duty laundry detergent without preservatives (pH 8.1), and the cleaning composition was an all-purpose detergent without preservatives (pH 7.6), each likewise made in the laboratory, without addition of the otherwise usual conventional preservatives.

### Procedure:

To each paint was added—individually and in combination—particular concentrations of guanidinium hydrochloride and benzisothiazolinone (BIT). The detergent and cleaning composition were admixed with particular concentrations of guanidinium hydrochloride and benzisothiazolinone (BIT).

The resultant batches of the paint thus prepared were inoculated with a mixture of various bacteria; the batches of the detergent and cleaning composition thus prepared were inoculated with a yeast mixture.

### Bacteria Mixture:

Pseudomonas spp. (Pseudomonas oleovorans group) DSM 33933
Pseudomonas aeruginosa DSM 33935
Pseudomonas oleovorans DSM 33936
Pseudomonas spec. DSM 33937
Pseudomonas aeruginosa DSM 33938

### Yeast Mixture:

Pichia manshurica DSM 12249
Rhodotorula mucilaginosa DSM 12248
Candida boidinii DSM 13622
Candida albicans DSM 1386

The inoculum was added to the respective sample in each inoculation at 2% (v/w) as a fresh cell suspension in a physiological saline solution (0.9% NaCl). The cell count of the inoculum added was 10⁹/ml for the bacteria mixture, 10⁸/ml for the yeast mixture, consisting in equal parts of the individual bacteria strains or yeast strains.

The cell suspension of the bacteria mixture was produced by growing the individual bacteria at 30° C. for 24 h in liquid culture on a shaker. The growth medium used for the bacteria was Müller-Hinton liquid medium. After growing, the individual liquid cultures were centrifuged, and the cells were resuspended in physiological saline solution. In order to adjust the mixture to a total cell count of 10⁹/ml, the individual bacteria suspensions, if necessary, were diluted accordingly before being combined with saline solution. The cell count of the inoculum was determined in each case by chamber counting.

The cell suspension of the yeast mixture was produced by growing the yeasts on Sabouraud glucose-agar at 25° C. for 48 hours and washing down the cell lawn with physiological saline solution (0.9% NaCl). Further steps for establishment of a cell count of the inoculum suspension of 10⁸/ml were effected analogously to the production of the bacteria suspension.

In examples 2 to 4, the samples were inoculated once with the respective cell suspensions (2% v/w) and the development of the bacteria or yeasts was followed by a semiquantitative evaluation method. In the inoculated samples, microbial infestation was evaluated in each case directly after inoculation on day 1 and on day 6 (emulsion paint) after incubation at 30° C. for a further 5 days, or on day 3 (detergent, cleaning composition) after incubation at 30° C. for a further 2 days. For this purpose, an aliquot was taken from each sample after homogenization using a sterile plastic inoculation loop (10 μl) and streaked evenly on agar plates (tryptic soy agar in the case of bacteria, Sabouraud glucose-agar in the case of yeasts). The streaked agar plates were then incubated at 30° C. for 48 hours (bacteria) or at 25° C. for 72 hours (yeasts). After incubation, the bacterial or yeast colonies that had grown on the agar plates were visually evaluated and quantified according to the following scheme:

| Evaluation | Growth on the agar surface |
|---|---|
| 0 | No growth |
| 1 | Minimal growth, 1 to 10 colonies visible over the entire |
| | streak |
| 2 | Light growth, maximum 100 colonies |
| 3 | Moderate growth, maximum 300 to 400 colonies |
| 4 | Uniform growth, >400 colonies, single colonies still |
| | clearly recognizable |
| 5 | Heavy growth, too many colonies to count, but no growth |
| | over the entire streak |
| 6 | Full growth, barely any single colonies still apparent, |
| | growth over the entire streak |

The results for examples 2 to 4 are shown in tables 2 to 4:

### EXAMPLE 2/TABLE 2

Inoculation 2% (w/v) with a Bacteria Mixture, Cell Count 10⁹/ml

Bacterial growth

| Concentration | Day 1 | Day 6 |
|---|---|---|
| Emulsion paint | | |
| No additives | 6 | 6 |
| +6000 ppm guanidine hydrochloride | 6 | 6 |
| (3708 ppm guanidine) | | |
| +500 ppm BITS | 6 | 6 |
| +300 ppm BIT + 1000 ppm guanidine | 6 | 0 |
| hydrochloride (618 ppm guanidine) | | |
| +200 ppm BIT + 2000 ppm guanidine | 6 | 0 |
| hydrochloride (1236 ppm guanidine) | | |

As can be inferred from the results shown in table 2, the synergistic interaction between BIT and guanidine, which has already been demonstrated above under laboratory conditions, can also be demonstrated in a practical application, in an emulsion paint.

### EXAMPLE 3/TABLE 3

Inoculation 2% w/v with a East Mixture, Cell Count 10⁸/ml

Bacterial growth

| Concentration | Day 1 | Day 3 |
|---|---|---|
| Detergent | | |
| No additives | 6 | 6 |
| +8000 ppm guanidine hydrochloride | 6 | 6 |
| (4944 ppm guanidine) | | |
| +100 ppm BITS | 6 | 4 |
| +30 ppm BIT + 3000 ppm guanidine | 6 | 2 |
| hydrochloride (1854 ppm guanidine) | | |
| +30 ppm BIT + 4000 ppm guanidine | 6 | 1 |
| hydrochloride (2472 ppm guanidine) | | |

As can be inferred from the results shown in table 3, the synergistic interaction between BIT and guanidine, which has already been demonstrated above under laboratory conditions, can also be demonstrated in a practical application, in a heavy-duty laundry detergent.

### EXAMPLE 4/TABLE 4

Inoculation 2% (w/v) with Yeast Mixture, Cell Count 10⁸/ml

Yeast growth

| Concentration | Day 1 | Day 3 |
|---|---|---|
| All-purpose detergent | | |
| No additives | 6 | 5 |
| +8000 ppm guanidine hydrochloride | 6 | 4 |
| (4944 ppm guanidine) | | |
| +100 ppm BITS | 6 | 4 |
| +30 ppm BIT + 3000 ppm guanidine | 6 | 0 |
| hydrochloride (1854 ppm guanidine) | | |
| +30 ppm BIT + 4000 ppm guanidine | 6 | 0 |
| hydrochloride (2472 ppm guanidine) | | |

As can be inferred from the results shown in table 4, the synergistic interaction between BIT and guanidine, which has already been demonstrated above under laboratory conditions, can also be demonstrated in a practical application, in a heavy-duty laundry detergent.

1. A composition comprising:
(a) guanidine and/or at least one salt of guanidine and
(b) 1,2-benzisothiazolin-3-one.

2. The composition as claimed in claim 1, characterized in that the guanidine salt present is guanidine hydrochloride and/or guanidine carbonate.

3. The composition as claimed in claim 1, characterized in that the weight ratio of (a) to (b) is in the range from 1.3:1 to 309:1, where the basis in the determination of the weight ratio in each case is the content with respect to the guanidine.

4. The composition as claimed in claim 1, further comprising:
(c) one or more zinc compound(s) selected from the group consisting of zinc oxide, zinc chloride, zinc sulfate, zinc phosphate, zinc carbonate, zinc hydroxycarbonate ([ZnCO3]2·[Zn(OH)2]3), zinc ascorbate, zinc hydroxide, zinc dehydroacetate and zinc carboxylate.

5. The composition as claimed in claim 1, characterized in that the weight ratio of (a) to (c) is in the range from 0.77:1 to 12:1, where the basis in the determination of the weight ratio in each case is the content with respect to the guanidine and zinc.

6. The composition as claimed in claim 1, further comprising:
(d) one or more compounds selected from sodium pyrithione, zinc pyrithione, 5-chloro-2-methyl-4-isothiazolin-3-one, 2-methyl-4-isothiazolin-3-one, N-methyl-1,2-benzisothiazolin-3-one, N-butyl-1,2-benzisothiazolin-3-one, octylisothiazolinone, bronopol, dibromonitrilopropionamide, iodopropynyl butylcarbamate, phenoxyethanol and dibromodicyanobutane.

7. The composition as claimed in claim 1, characterized in that the composition is an industrial product selected from the group consisting of:
lignosulfonates and starch preparations in paints, colors, varnishes, glazes and renders, emulsions, latices, polymer dispersions, chalk slurries, mineral slurries, ceramic compounds, adhesives, fragrances, casein-containing products, starch-containing products, bitumen emulsions, surfactant solutions, fuels, detergents, cleaning compositions, pigment pastes and pigment dispersions, inks, lithography fluids, thickeners, cosmetic products, toiletries, water cycles, wood processing fluids, petroleum production fluids, paper processing fluids, leather manufacturing fluids, textile manufacturing fluids, drilling and cutting oils, hydraulic fluids, cooling lubricants and biocidal products.

8. The composition as claimed in claim 1, characterized in that it has a pH in the range from pH 4.5 to pH 12.

9. The composition as claimed in claim 1, characterized in that the composition contains components:
(a) in an amount in the range from 100 to 10 000 ppm, based on the amount of guanidine in the composition, and
(b) in an amount in the range from 1 ppm to 1000 ppm.

10. The composition as claimed in claim 4, characterized in that this composition contains component:
(c) in an amount in the range from 10 to 5000 ppm, based on the amount of zinc in the composition.

11. The composition as claimed in claim 6, characterized in that the composition contains component:
(d1) phenoxyethanol in an amount in the range from 100 to 10 000 ppm and/or
(d2) one or more compounds selected from sodium pyrithione, zinc pyrithione, 5-chloro-2-methyl-4-isothiazolin-3-one, 2-methyl-4-isothiazolin-3-one, N-methyl-1,2-benzothiazolin-3-one, N-butyl-1,2-benzisothiazolin-3-one, octylisothiazolinone, bronopol, dibromonitrilopropionamide, iodopropynyl butylcarbamate, and dibromodicyanobutane in a total amount in the range from 1 to 1000 ppm.

12. The composition as claimed in claim 1, characterized in that it has a water content of greater than 10% by weight.

13. An aqueous composition selected from the group consisting of paints, colors, varnishes, glazes and renders, emulsions, latices, polymer dispersions, mineral slurries, pigment pastes and pigment dispersions, detergents and cleaning compositions, comprising:
(a) 200 to 7500 ppm of guanidine and/or at least one salt of guanidine,
(b) 1 to 1000 ppm of 1,2-benzisothiazolin-3-one,
(c) 10 to 5000 ppm of zinc oxide,
(d1) 1 to 150 ppm of 2-methyl-4-isothiazolin-3-one and
(d2) 1 to 100 ppm of 5-chloro-2-methyl-4-isothiazolin-3-one.

14. The use of:
(a) guanidine and/or a salt of unsubstituted guanidine for improvement of the antimicrobial efficacy of
(b) 1,2-benzisothiazolin-3-one.
